(19) United States
(12) Patent Application Publication
(10) Pub. No.: US 2006/0116951 A1
(43) Pub. Date: Jun. 1, 2006

(54) Method and system for living expense arbitrage across borders by retirees

(76) Inventors: Yong On Kim, Palisades, NY (US); Ashish Kumar Dev, Shaker Heights, OH (US)

Correspondence Address: Mr. Yong O. Kim, 418 White Oak Road, Palisades, NY, 10964, US

(21) Appl. No.: 10/999,628

(22) Filed: Nov. 30, 2004

(51) Int. Cl. G06Q 40/00

(52) U.S. Cl. 705/38

(57) ABSTRACT

This invention identifies the economic benefits of living in a foreign country, where the cost of living is a fraction of the cost of living in the U.S., for retirees. Specifically, the method addresses the needs of those retired homeowners who will consider living abroad only a portion of the year while keeping their current homes as primary residences. A computer-implemented method determines the amount saved from living abroad for part of year for retirees who would buy a second home in a foreign country financed by reverse mortgages. Clearly, the level of saving or benefit depends crucially on the price of the second home in the foreign country, the difference between two countries' living expenses, and the number of months retirees plan to stay in the foreign country, among other inputs. Higher the amount saved, the more likely the retirees in high living-cost areas in the U.S. look into this option of living abroad, particularly those first-generation immigrant senior citizens. The method also addresses assessing the feasibility of developing residential communities in foreign countries for the U.S. senior citizens by developers. Specifically, given the cost of developing such communities abroad, the method determines the minimum threshold of living expense in the U.S. This minimum threshold of living expense in the U.S. will, in turn, determine the market segment or client base in the U.S., which the developer can target.

### REFERENCES

U.S. Patent Documents

| | | |
|---|---|---|
| 20040015389 | January 2004 | Dubner, Peter H. |
| 20030023544 | January 2003 | Chodes, Gary |
| 20020138312 | September 2002 | Blau, Joseph D. |
| 20020055905 | May 2002 | Jannah, Shekar; et al. |

Other References
Reverse mortgages from FannieMae web cite, eFannieMae.com
National Reverse Mortgage Lenders Association web cite, www.reversemortgage.org
Social Security Online, Actuarial Publications, Statistical Tables, “Benefits paid, by type of benefit and trust funds, 2003,” and “Number of Beneficiaries, 2003.”
Social Security Administration Publication #05-10137, ICN 480085, July 2002.
U.S. Census Bureau, “Income, Poverty, and Health Insurance Coverage in the United States: 2003,” Aug. 2004.

### BACKGROUND OF THE INVENTION

1. Field of Invention

A computer-implemented method used in determining the amount saved from living abroad for a part of year for retirees, and in testing the feasibility of developing residential communities in a foreign country for the U.S. senior citizens. The present invention identifies the economic benefits of living part of year in the foreign country where the cost of living is low for retired homeowners who currently live in high living-cost areas in the U.S.

2. Description of the Related Art

As the population is growing older and the older generation lives longer, high living expense in the United States will become a serious concern for a large segment of retirees, many of whom rely mainly on social security benefits. In 2003, Social Security trust fund paid total cash benefit $399.892 billion to 39,443,023 recipients (Social Security Online, Actuarial Publications, Statistical Tables: Benefits paid, by type of benefit and trust fund; Number of beneficiaries). That is, average cash benefit per recipient was $10,138 in the year 2003. According to U.S. Census Bureau, poverty thresholds in 2003 for families of householder 65 years or older were $8,825 for a family size of 1 person and $11,122 for that of 2 people. Although most families of householder 65 years or older are not considered to be below the poverty thresholds, it seems clear from these data that many of retirees living in high cost metropolitan areas are under tight budget conditions.

For this group of retirees, living in a foreign country where living expense is a fraction of that in the U.S. may be a viable alternative to living in high living-cost areas in the U.S. Beside the economic reason, many first-generation immigrant senior citizens, most of who are clustered in high living-cost metropolitan areas of big cities, maintain their ties to their homelands, and may wish to live there. However, many, if not most, of these groups of senior citizens may be reluctant to move permanently to foreign countries due to their network of friends and family members (children and relatives) in their current residential areas. If housing prices in those countries are low enough and the law allows foreigners to own real estate properties, it may be possible for the management or developers of residential real estate in those countries to offer living quarters (condominiums or town houses) to these U.S. senior citizens at affordable prices. Retired senior citizens who intend to live in the foreign countries for a portion of each year can finance the purchase of these houses with reverse mortgages from their current houses. Reverse mortgages are particularly well suited for financing this type of purchase.

A reverse mortgage is a special type of loan used by elderly seniors to cash out the equity build-up in their homes without selling them. No payments are due on a reverse mortgage while it is outstanding. The loan becomes due and payable when the borrower ceases to occupy his/her home as a principal residence. This can occur if the borrower (the last remaining spouse, in cases of couples) passes away, sells the home, or permanently moves out. The money from a reverse mortgage can be used for anything. The borrower can choose how to receive the money from a reverse mortgage. The options are: all at once (lump sum); fixed monthly payments (for up to life); a line of credit; or a combination of these. The most popular option is the line of credit, which allows the borrower to draw on the loan proceeds at any time. The size of a reverse mortgage varies with: (1) the borrower's age; (2) the value of the home; and (3) current interest rates. The location of the home also affects the loan size. The maximum size of a reverse mortgage depends on the FHA loan limit, which varies from area to area and is usually adjusted annually. For example, as of 2004, the FHA loan limit varies from a low of $160,176 for rural areas to a high of $290,319 for high-cost metropolitan areas.

A U.S. citizen can live in most foreign countries without affecting his/her eligibility for Social Security benefits except few countries—Cambodia, Cuba, North Korea, Vietnam and many of the former U.S.S.R. republics (except Armenia, Estonia, Latvia, Lithuania and Russia)—where Social Security Administration cannot send Social Security checks. Further, Social Security payment can be deposited directly in a financial institution in the country where a recipient lives. The list of countries where direct deposit is available can be found in SSA Publication #05-10137, ICN 480085, July 2002. For a non-U.S. citizen Social Security recipient, the duration that one can stay outside the U.S. is in general limited to six calendar months. There are several exceptions in the law that will permit the non-U.S. citizen Social Security recipient to continue receiving benefits abroad. These exceptions are based, for the most part, on the person's citizenship. For example, if a Social Security recipient is entitled to worker's benefits and is a citizen of one of the many countries with which the U.S. has a reciprocal arrangement to pay each other's citizens in another country, his/her Social Security benefits may continue even after he/she leaves the U.S. As for health insurance coverage, Medicare does not cover beneficiaries abroad.

In this invention, we calculate savings of cash flows from living abroad based on the notion that the equivalent annuity cost of owning a second home abroad is interest payment on reverse mortgage plus the maintenance cost of that house as if borrowers pay interest on reverse mortgages. In this way, the borrower's net wealth level will be held constant as the new property value is cancelled with the liability of the reverse mortgage.

Computer systems can assist in calculating the amount saved per year from living abroad after inputting the price of a second home in a foreign country, interest rate on reverse mortgage, living expenses home and abroad, foreign currency exchange rate, maintenance expense at home during the stay abroad, number of months staying abroad, and travel expenses. As an example, consider a couple: Both are first-generation immigrant, U.S. citizens, retired and own a house in a high-living cost area, living on Social Security benefit $2000 per month which is living expense per month. Suppose that they are considering an option to live in their homeland for six months per year, where living expense is only $800 per month. Suppose that a condominium price in that country is $40,000, and they can finance this new second house by a reverse mortgage at 7% interest. In this case, equivalent annuity cost of owning the second home is $233 per month ($40,000×0.07/12). The round trip to the homeland will cost them $2400. Further, the couple must pay $200 per month whether they stay at home or not, for example, car and home insurance payments, some utility payment including basic phone bill, etc. This $200 is part of living cost $2,000 at home. Living abroad for 6 months will cost them $233×6+$800×6+$200×6+$2400=$9,800. Since 6-month living expense at home is $12,000, living abroad results in $2,200 of savings for the 6-month period. However, there is an additional expense while at home, i.e., the annuity cost of owning the second home, $233×6=$1,400. Hence, in this case, the net saving is $800 per year. Clearly, a lot depends on input variables. For instance, if the price of the new second home in the homeland is $30,000, then the net saving per year will be $1,500 per year, which may be a considerable amount for this couple.

### SUMMARY AND OBJECTIVES OF THE PRESENT INVENTION

A computer-implemented method used in determining the amount of savings from living abroad for a part of year for retirees who would buy a second home in a foreign country financed by reverse mortgages, and in testing the feasibility of developing residential communities in foreign countries for the senior U.S. citizens.

Given the current reverse mortgage rate and the price of a second home in a foreign country, the method first calculates the equivalent annuity cost of owning a second home in the foreign country, i.e., monthly interest on the reverse mortgage plus monthly maintenance cost of the second home. Combing this with monthly living expense yields monthly expense living in the foreign country. By multiplying this monthly expense to the number of months per year (e.g., six months) that a retired couple from the U.S. plans to live in the second home in the country, the total living expense abroad can be obtained. However, there are other costs incurred during this period. First, the round trip to this country will cost the couple a traveling expense. Second, certain fixed expenses must be paid for their current primary residency during the time of living abroad. These are expenses that occur whether they stay at home or not, for example, car and home insurance payments, some utility payment including basic phone bill, etc. Adding these two additional costs to the total living expense abroad will result in total cost of living abroad.

The difference between living expenses at home during the period of living abroad and the above total cost of living abroad is the net savings while living abroad. During the period living at home, there is additional cost now, i.e., the equivalent annuity cost of owning a second home abroad. During the period at home, the equivalent annuity cost of owning the second home abroad must be subtracted from the net saving while living abroad. The result is the true annual savings from living abroad. Clearly, the level of savings depends crucially on the price of the second home in the foreign country, the difference between two countries' living expenses, and the number of months retirees plan to stay in the foreign countries, among other inputs. Higher the level of savings is, the more likely the retirees in high living-cost areas in the U.S. look into this option of living abroad, particularly those first-generation immigrant senior citizens.

Given the unit cost of developing such community in a foreign country suitable for retired homeowners in the U.S. and the living expense in that country, one can back out the minimum-threshold living expense in the U.S., provided that all other inputs are supplied at the proper levels. As soon as a country is fixed, the feasibility test of undertaking such project will be based on the demography of those first-generation immigrants, retired, living in the U.S. Specifically, the likelihood of successful marketing strategy will come from the well-thought out research targeting the above seniors living in areas where living expenses are well over the minimum-threshold living expense.

Benefit of this invention is to identify the economic benefits that some segment of retired homeowners, especially those first-generation immigrants, expropriate the differential living expense between the U.S. and a foreign country by living in that country for a portion of each year while maintaining their current homes as their primary residencies. In a process of the living expense arbitrage, the homeowners purchase second homes in the foreign country, financing the purchase by reverse mortgages. Because of inherent preference for their homelands by first-generation immigrants, the invention provides a method of which specific segments of clients the management or developers of residential properties target in their marketing campaign.

### BRIEF DESCRIPTION OF THE DRAWINGS

FIG. 1 depicts an information flow chart relevant to estimating the equivalent annuity cost of owning a second home in a foreign country.

FIG. 2 depicts in block diagram format, the estimation of total cost of living in the foreign country including travel expenses and fixed expense incurred in the primary residence while abroad.

FIG. 3 depicts in block diagram format, the estimation of annual saving from living abroad. Net saving accrued while living abroad is the difference between total cost of living in the foreign country and living expense incurred if stayed home. This net saving is adjusted for the equivalent annuity cost of owning a second home incurred while staying home, resulting in true saving from living abroad where living expense is much lower than that in the U.S.

FIG. 4 depicts an input-output model for computation of the amount saved from living abroad. The input-out model is a summary of FIG. 1, FIG. 2 and FIG. 3.

FIG. 5 depicts a business model for real estate developers in a foreign country. It briefly describes how the break-even unit price is obtained. Inputting this and the monthly unit maintenance cost into the input-output model in FIG. 4 and setting the amount saved from living abroad at zero will yield the minimum threshold of living expense at the U.S. This minimum threshold of living expense in the U.S. will, in turn, determine the market segment or client base in the U.S., which the developer can target.

### DETAILED DESCRIPTION OF THE INVENTION

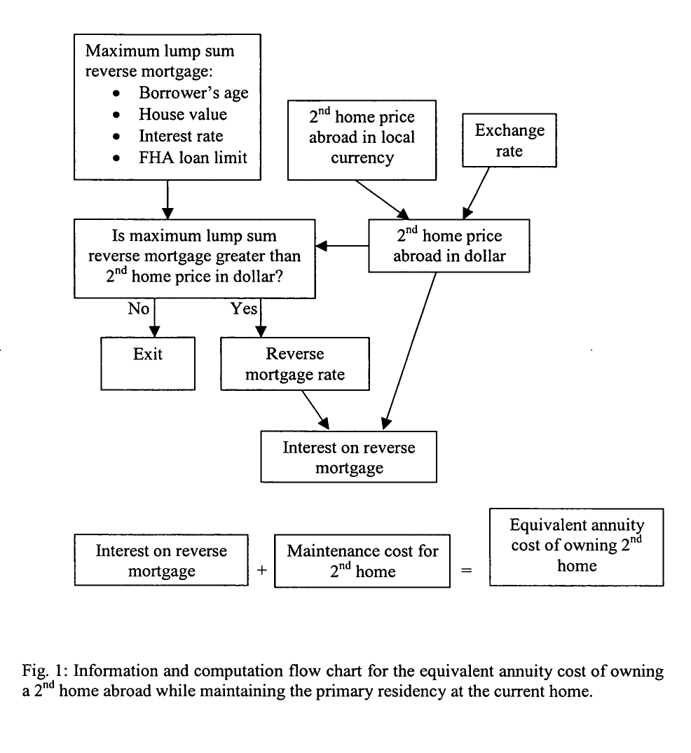

In FIG. 1, a borrower's information such as age, the value of house and FHA loan limit based on the location of the house, and mortgage rate will determine the maximum amount of reverse mortgage. As long as the price of 2^{nd} home in a foreign country in dollar is below the maximum amount of reverse mortgage, the borrower can purchase the 2^{nd} home in that country with the lump sum amount of reverse mortgage. Let F be the price of 2^{nd} home in a foreign country in dollar, rr the reverse mortgage rate, and mc the maintenance cost of the 2^{nd} home. Monthly interest on the reverse mortgage is rr·F/12 and monthly maintenance cost is mc/12. Sum of the two costs, (rr·F+mc)/12, is equivalent to monthly annuity cost of owning a house abroad. It is in some sense implicit rent on a 2^{nd} home abroad, whether borrowers actually choose to pay interest on reverse mortgages or not. Note that when the borrower pays interest on the reverse mortgage, his/her equity level will be held constant as the new property value is cancelled with the liability of the reverse mortgage.

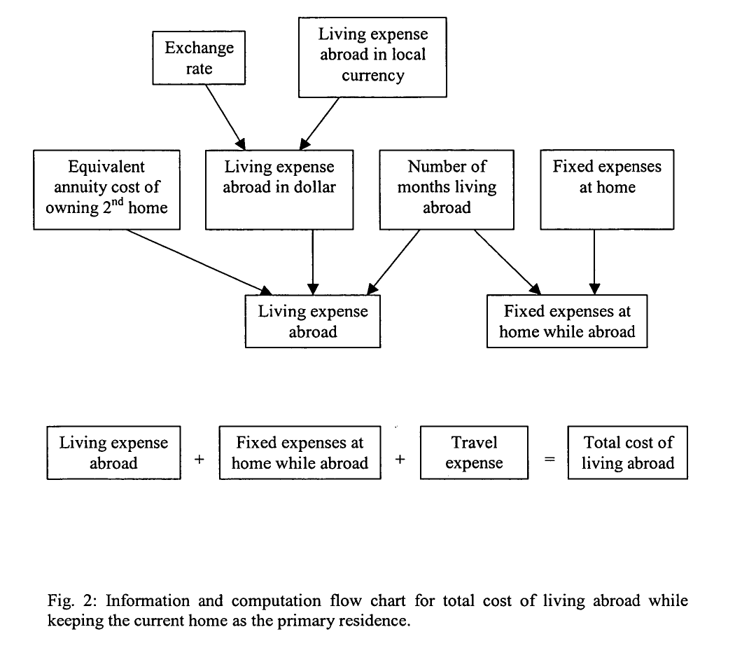

In FIG. 2, the implicit monthly rent on the 2^{nd} home in the foreign country plus monthly living expense in the country (LEF) yields monthly expense living in the 2^{nd} home in the country. Specifically, it is (rr·F+mc)/12+LEF. By multiplying this monthly expense to the number of months (N) living abroad per year (e.g., six months), the total living expense abroad can be obtained. That is, [(rr·F+mc)/12+LEF]·N. However, there are other costs incurred during this period. First, traveling expense (TE). Second, certain fixed expenses must be paid for the current primary residency during the time of living abroad. These are expenses that occur whether staying at home or not. For example, car and home insurance payments, property taxes, some utility payment including basic phone bill, etc. Let FE be such expense per month. Adding these two additional costs to the total living expense abroad will result in total cost of living abroad, i.e., [(rr·F+mc)/12+LEF+FE]·N+TE.

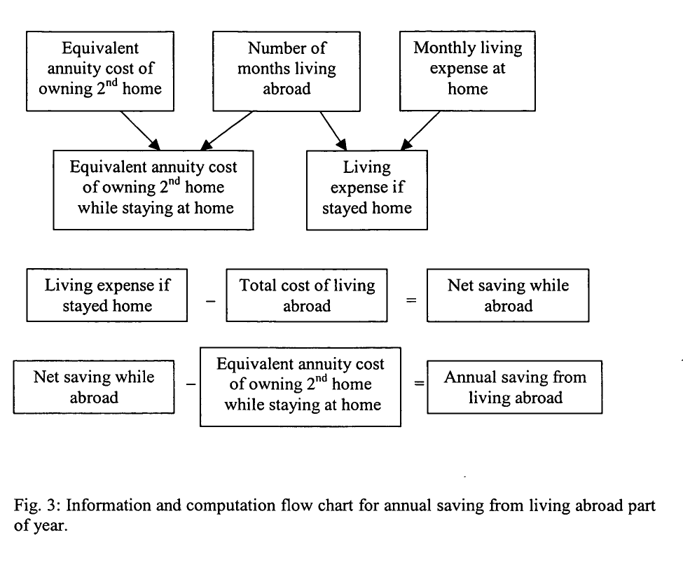

In FIG. 3, the difference between living expenses at home during the period of living abroad and the above total cost of living abroad is the net saving while living abroad. Let LEH be monthly living expense at home. Then, the net saving while living abroad is [LEH−(rr·F+mc)/12−LEF−FE]·N—TE. There are additional costs now from owning a second home abroad during the period living at home. Implicit rent on the 2^{nd} home abroad during the period living at home must be subtracted from the net saving while living abroad, resulting in the true annual saving from living abroad, i.e., [LEH−LEF−FE]·N−TE−(rr·F+mc). Clearly, the amount saved depends crucially on the price of the second home in the foreign country, the difference between two countries' living expenses, and the number of months retirees plan to stay in the foreign countries, among other inputs. Higher the amount saved, the more likely the retirees in high living-cost areas in the U.S. look into this option of living abroad, particularly those first generation immigrant senior citizens.

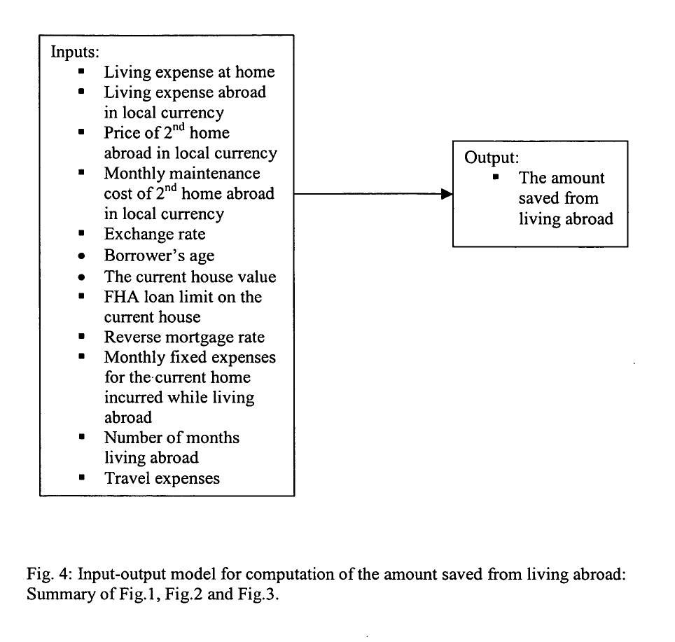

In FIG. 4, an input-output model is a summary of FIG. 1, FIG. 2 and FIG. 3. Inputs are:
Living expense at home (LEH)
Living expense abroad in local currency (LEF^{1c})
Price of 2^{nd} home abroad in local currency (F^{1c})
Maintenance cost of 2^{nd} home abroad in local currency (mc^{1c})
Exchange rate (x=1c/$)
Borrower's age (y)
The current house value (H)
FHA loan limit on the current house (FHA)
Reverse mortgage rate (rr)
Monthly fixed expenses for the current home incurred while living abroad (FE)
Number of months living abroad (N)
Travel expenses (TE)

Output is:
Savings from living abroad (S)

FIG. 4 without any other figures would be like a black box. However, each part of the model is already described in details in the previous figures. There are risk factors need to be considered due to volatilities of reverse mortgage rate and exchange rate. Let σᵣᵣ and σₓ be volatilities of reverse mortgage rate and exchange rates respectively. Then, we will adjust for the interest on reverse mortgage as rr·(1+σᵣᵣ)·F, and for living expense abroad as LEF=LEF^{1c}/(x·(1−σₓ)) and for maintenance cost for 2^{nd} home abroad as mc=mc^{1c}/(x·(1−σₓ)).

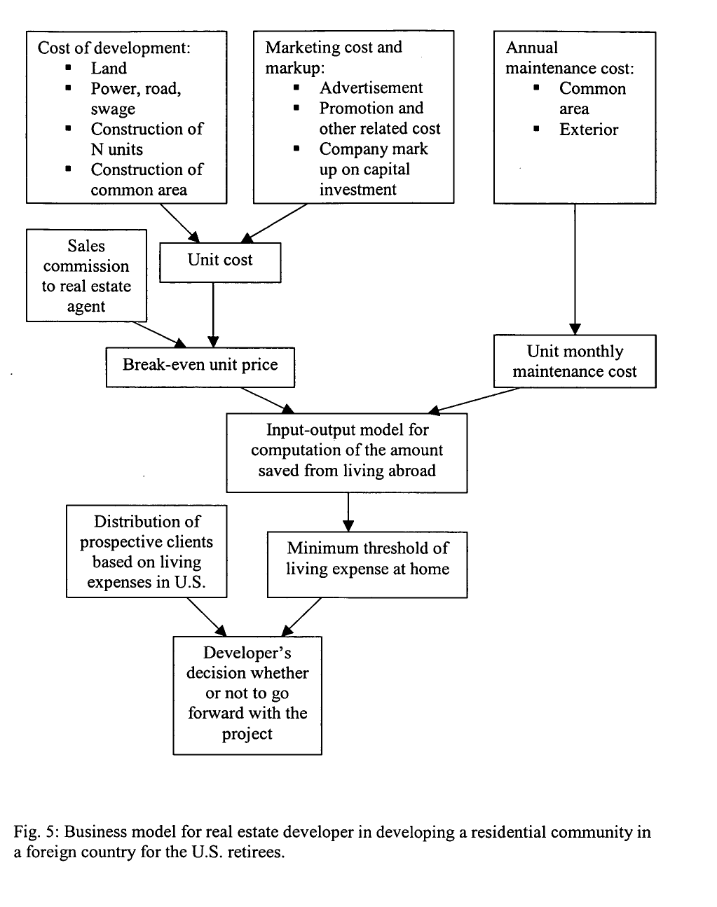

FIG. 5 depicts a business model for real estate developers in a foreign country. It briefly describes how the break-even unit price is obtained. Inputting this and the monthly unit maintenance cost into the input-output model in FIG. 4 and setting the amount saved from living abroad at zero will yield minimum threshold of living expense at the U.S. This minimum threshold of living expense in the U.S. will, in turn, determine the market segment or client base in the U.S., which the developer can target.

The above-described arrangement is merely illustrative of the principles of the present invention. Numerous modifications and adaptations thereof will be readily apparent to those skilled in the art without departing from the spirit and scope of the present invention.

What is claimed is:

1. A computer-implemented method used in determining the amount saved from living abroad for a part of year for retirees who would buy a second home in a foreign country financed by reverse mortgages.

2. The method of claim 1, wherein determining the amount saved from living abroad includes: inputting the borrower's age, the assessed house value, FHA loan limit on the current house, reverse mortgage rate; inputting living expense at home, monthly fixed expense at home; inputting living expense abroad in local currency, price of 2^{nd} home abroad in local currency, monthly maintenance cost of 2^{nd} home abroad in local currency, exchange rate; inputting number of months living abroad, travel expenses.

3. The method assesses the feasibility of developing residential communities in a foreign country for the senior U.S. citizens.

4. The method of claim 3, wherein determining the minimum threshold of living expense in the U.S. includes: inputting break-even unit price in the place of price of 2^{nd} home abroad in local currency, unit monthly maintenance cost in the place of monthly maintenance cost of 2^{nd} home abroad in local currency in the input-output model; setting the amount saved from living abroad at zero in the input-output model.

5. The method of claim 3, wherein determining the feasibility of developing residential communities in a foreign country for the senior U.S. citizens; inputting the minimum threshold of living expense in the U.S.; inputting distribution of prospective clients in the U.S. whose living expenses are greater than the minimum threshold of living expense.
